(19) United States
(12) Patent Application Publication
(10) Pub. No.: US 2004/0060820 A1
(43) Pub. Date: Apr. 1, 2004

(54) Characterization of particles by position in an electric field

(76) Inventor: Vincent Edward Bressler, Menlo Park, CA (US)

Correspondence Address: Vincent Bressler, 240 East Creek Drive, Menlo Park, CA, 94025, US

(21) Appl. No.: 10/263,025

(22) Filed: Oct. 1, 2002

(51) Int. Cl. G01N 27/26; G01N 27/447

(52) U.S. Cl. 204/547; 204/643

(57) ABSTRACT

A method and apparatus are disclosed which characterize the physical properties of particles (21). The apparatus measures the position (22) of particles with respect to the center (32) of electrodes (28) (30) as the dielectrophoretic forces (24) (26) on the particles are modified. A signal source (34) is used to induce dielectrophoretic forces on the particles.

### FEDERAL SPONSORED RESEARCH AND DEVELOPMENT

The invention was conceived and developed without aid of any government sponsorship.

### BACKGROUND OF THE INVENTION

1. Field of the Invention

This invention relates to the characterization of the electrical properties of particles.

2. Prior Art

A particle is a discrete structure that responds as one entity. Particles may be molecules, biological cells, or larger structures. Characterization is an indirect method of gathering information about the physical structure or state of particles. To characterize a particle it is necessary to first alter the environment around the particle and second, measure the change to the particle. Depending on its physical structure, each particle will respond differently to the same environmental change. Characterization is the process of measuring different responses.

One method for characterizing particles is dielectrophoresis. To perform characterization via dielectrophoresis, first induce an appropriate electrical field around the particles using an electrode structure and signal generator, then measure the force exerted on the particles by that field. The strength of the force depends on the size, electrical and structural properties of the particle, the electrical properties of the fluid, the amplitude, frequency and structure of the applied electric field. Characterization may involve variation of the amplitude, frequency, or structure of the electric field. Likewise, characterization may involve variation of the electrical properties of the fluid containing the particles being characterized.

Dielectrophoretic characterization may be used to determine the condition of living cells without harming the cells, Ratanachoo et al., “Detection of cellular responses to toxicants by dielectrophoresis”, Biochimica et Biophysica Acta 1564 (2002) 449-458.

Likewise dielectrophoretic characterization may be used to determine the biological state of living cells, Pethig et al., “Dielectrophoretic studies of the activation of human T lymphocytes using a newly developed cell profiling system”, Electrophoresis 23 (2002) 2057-2063.

Also, dielectrophoretic forces may be used to separate different types of cells, Huang et al., “Dielectrophoretic Cell Separation and Gene Expression Profiling on Microelectronic Chip Arrays”, Anal. Chem. 74, (2002) 3362-3371. In this case characterization informs the selection of signal frequencies, amplitudes, and fluid conductivity that may be used to separate particles.

U.S. Pat. No. 6,264,815 to Pethig et al. (1999) describes a method to characterize particles using dielectrophoresis. With that method particles are attracted to various locations on an array of electrodes. The approach has several drawbacks. First, it requires the generation and distribution of a variety of electrical signals. Second, the characterization data derived is granular because the apparatus requires separate signal paths for each gradation in the measurement. Third, particles must cross paths in order to find the attracting electrode. While in transit, many particles are blocked or diverted. Fourth, particles must be detected while they adhere to electrodes. This is difficult to do since the, electrodes obscure the particles.

U.S. Pat. No. 5,344,535 to Betts et al. (1993) describes a method for characterizing particles as they move over an electrode surface via bulk fluid flow. The dielectrophoretic force from a set of electrodes traps particles. This method has many of the drawbacks of the previously cited patent and additional problems. First, the chamber must be low, restricting particles to the space just above the electrodes. This increases the opportunity for particles to collide with one another or with the electrodes. Such collisions may damage particles and provide an opportunity for particles to become stranded, thereby disrupting the measurement. Second, the fluid flow must be fast enough to move the particles along, but not so fast as to prevent particles from adhering.

U.S. Pat. No. 4,956,065 to Kaler et al. (1988) describes a method for levitating a single particle using an active feedback mechanism. This method may only process one particle at a time for each set of control electronics and processor. Also, precise initial positioning of the particle is required.

U.S. Pat. No. 4,326,934 to Pohl (1979) describes a method for characterizing particles where the particles flow past a set of electrodes that redirect their path. This method has the following drawbacks. First, the method processes only one particle at a time for each set of control electronics and processor. Second, only a single frequency and amplitude may be used for each pass. Third, the measurement is granular because each gradation of the measurement requires independent electrode and signal pathways.

Ratanachoo et al., “Detection of cellular responses to toxicants by dielectrophoresis”, Biochimica et Biophysica Acta 1564 (2002) 449-458, describes a method for characterizing particles by finding a signal frequency where particle motion stops. This technique requires a relatively large, unobstructed observation area for each particle. Only a small number of particles may be measured at once. Particles rest on the substrate surface during the measurement. The precision of this measurement is poor because of friction or chemical binding between the particles and the substrate.

### SUMMARY OF THE INVENTION

The present invention is a method and apparatus for performing dielectrophoretic characterization by precisely measuring the position of particles multiple times as they are subjected to different electrical fields.

### OBJECTS AND ADVANTAGES OF THE INVENTION

The invention provides precise characterization by measuring the position of individual particles for a particular range of frequency settings. The number of images that must be processed is small compared to systems that track particles. Total particle motion using this technique is small, therefore a large number of particles may be measured at once without interference. The extent to which substrate friction or chemical binding affects the measurement may be controlled via the timed sequence of signal frequencies and amplitudes. The interdigitated electrodes used in the preferred embodiment provide a simple reference coordinate system for the electrical field. Only one pair of electrical connections is required. Only one electrical signal is required. The granularity of the measurement is limited only by the ability to resolve the position of each particle. Particles are not made to travel across electrodes or to cross paths as part of this measurement process. This reduces the possibility of measurement error caused by particle to particle interactions. Other methods require that particles be counted while they are in contact with opaque electrodes. Such counts are prone to error. The measurement may be performed rapidly on a large number of particles. Further objects and advantages of the invention will become apparent from an inspection of the ensuing drawings and description.

### DESCRIPTIONS OF DRAWINGS

FIG. 1 illustrates the method of the invention.

FIG. 2 is a schematic drawing of the apparatus for the preferred embodiment of the invention.

FIG. 3 is a plan drawing of the electrode and signal connection for the preferred embodiment of the invention.

FIG. 4 is a cross-sectional view of the structure of the electrode for the preferred embodiment of the invention.

FIG. 5 explains how the position measurement of the particle is not sensitive to height.

FIG. 6 explains the algorithm that is used to find electrode positions.

FIG. 7 explains the algorithm that is used to find particles.

FIG. 8 shows a flowchart of the algorithm to find particles in images.

FIG. 9 explains one possible data reduction algorithm to convert particle positions to characterization charts.

FIG. 10 illustrates the algorithm that is used to fit a circle to a particle image.

FIG. 11 shows a flowchart of the algorithm that is used to fit a circle to a particle image.

FIG. 12 is a flowchart of the algorithm that is used to modify the signal and capture images.

FIG. 13 shows several possible signal types that may be applied to the electrodes.

FIG. 14 shows an embodiment of the invention that includes two signal generators.

FIG. 15 shows an embodiment of the invention that includes curved electrodes.

FIG. 16 shows an embodiment of the invention that includes fiducials.

FIG. 17 shows an embodiment of the invention that includes a chemical coating on the substrate.

FIG. 18 illustrates the three dimensional geometry of the preferred embodiment.

FIG. 19 shows the path of particle motion during the characterization process.

FIG. 20 shows the forces on a particle and the structure of the electrical field around a particle.

### DESCRIPTION OF REFERENCE NUMBERS

21—Suspended particle

22—Distance from center of nearest electrode to center of suspended particle

24—Net dielectrophoretic force pushing suspended particle away from nearest electrode

26—Net dielectrophoretic force pushing suspended particle away from second nearest electrode

28—Electrode nearest to suspended particle

30—Second nearest electrode to suspended particle

32—Center of electrode that is nearest to suspended particle

34—Voltage signal source that is connected to the electrodes

40—Microscope body

42—Microscope lens system

44—Video camera

46—Computer

48—Light source for the microscope

49—Aperture for light source

50—Aperture mechanism for light source

52—Fluid-filled chamber

54—Glass cover over the top of the fluid filled chamber

56—Sidewall of fluid filled chamber

58—Glass substrate upon which the electrode is fabricated

60—Connection point between signal source and left side electrode conductive surface

62—Connection point between ground and right side electrode conductive surface

64—Left side conductive surface of the electrode

68—Right side conductive surface of the electrode

70—Spacing between electrodes

72—Width of an electrode

74—Chrome adhesion layer of electrode between gold and glass substrate

75—Gold primary conductive layer of electrode

76—Ray from right side of aperture through the center of the suspended particle

78—Ray from left side of aperture through the center of the suspended particle

80—Height of the suspended particle above the glass substrate

82—Video detector

86—Maximum angle of all rays passing through the center of the particle

90—Intensity trough from adding pixel values horizontally across an electrode

92—Image of the parallel electrodes

94—Image of one electrode

96—Cutoff amplitude for finding electrode positions in the image

98—Start boundary of one electrode

99—End boundary of one electrode

100—Minimum intensity in the horizontal sum for one electrode

102—Center of one electrode as determined by the minimum intensity sum

104—Image containing idealized representation of electrodes

110—Portion of an unprocessed image containing idealized electrodes and particles

112—Portion of a processed image containing electrodes and particles

114—Unprocessed image of a particle on an electrode

116—Noise from an unprocessed image

120—Unprocessed image of a particle

121—Idealized, processed image of a particle

126—Plot of average cell position vs. frequency for one characterization run

128—Crossover frequency

130—Unprocessed image of one particle with fitted circle shown

132—Circle that has been fitted to the particle boundary

134—Center of the circle that has been fitted to the particle boundary

135—Distance from inner pixel to edge of fitted circle

136—Boundary pixels that are outside of the fitted circle

137—Distance from outer pixel to edge of fitted circle

138—Boundary pixels that are inside of the fitted circle

144—Single frequency signal

146—Dual frequency, amplitude modulated signal

148—Dual frequency, frequency shift modulated signal

150—Signal source connected to right side electrode in dual source embodiment

151—Signal source connected to left side electrode in dual source embodiment

152—Interior electrode in ball and socket embodiment

153—Exterior electrode in ball and socket embodiment

154—Transparent right side electrode

155—Transparent left side electrode

156—Fiducial mark in the center of transparent electrode

157—Distance from center of electrode fiducial to center of particle

158—Distance from off electrode fiducial to center of particle

159—Off electrode fiducial

160—Bar code fiducial

162—Individual molecule of chemical coating on surface of substrate

164—Individual phospholipid molecule in membrane of particle

170—Line of constant electrical field strength

172—Charge inside the particle membrane on the right side

174—Charge inside the particle membrane on the left side

176—Net force on the left side particle membrane

178—Net force on the right side particle membrane

180—Net force on the particle

### STRUCTURAL DESCRIPTION OF THE INVENTION

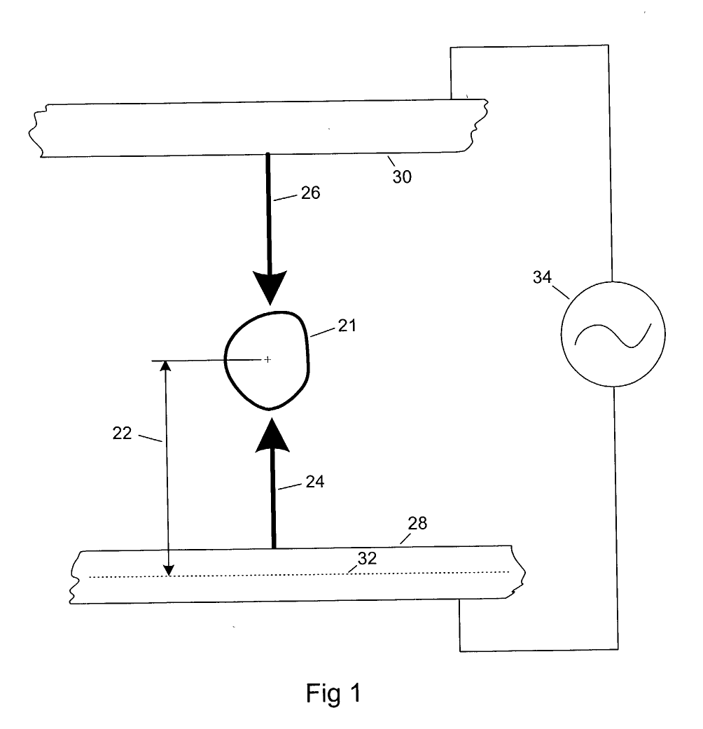

FIG. 1 illustrates the preferred embodiment of the invention. An electrode structure 28, 30, and signal source 34, generate an electric field around the particle 21. The signal source 34 provides a time varying voltage. Therefore the electric field between the electrodes is time varying. The time varying amplitude of the electric field around the particle decreases as the distance 22 between the particle and the center 32 of the nearest electrode increases. Under certain conditions the electric field causes repulsive forces 24, 26 between the particle and each of the electrodes. When the forces are repulsive, the particle is elevated above and centered between the electrodes. The strength of the repulsive forces is related to the amplitude and frequency of the electric field around the particle and to the electrical properties of the particle. As the frequency of the signal increases, the forces become attractive and the particle is pulled toward the nearest electrode. By measuring the distance between the particle and the center of the nearest electrode at a range of frequencies, the dielectrophoretic properties of the particle may be characterized.

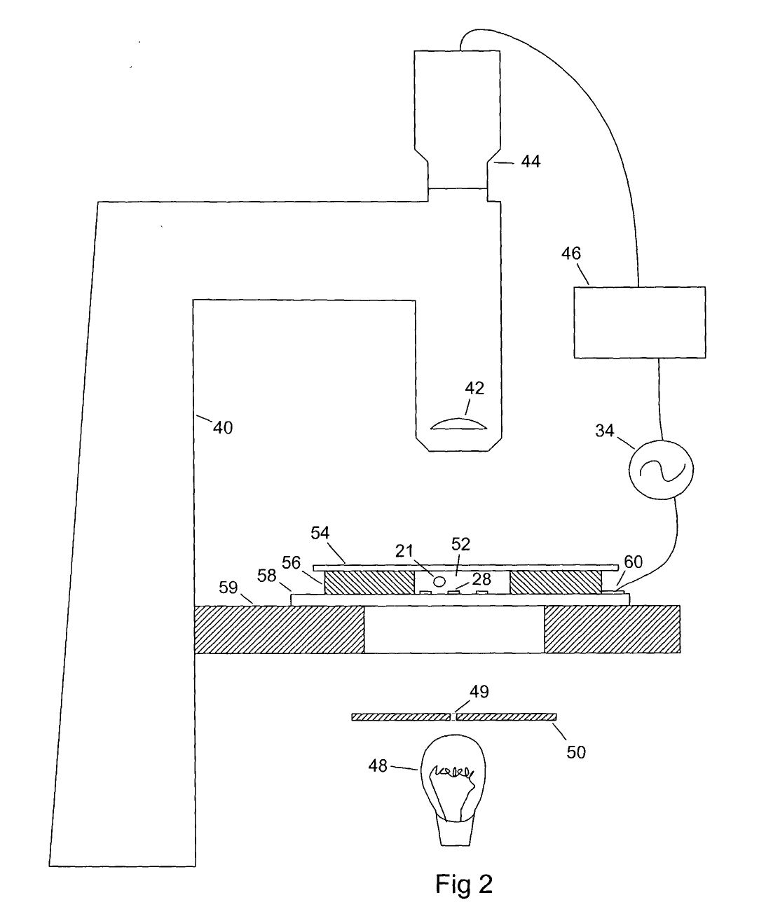

FIG. 2 shows the preferred embodiment of the invention. A population of particles of which the particle, 21, is a single member, is suspended above a set of conductive electrodes 28 in a fluid-filled chamber 52. The electrodes are attached to a glass substrate 58. The walls of the fluid-filled chamber 56 are outside of the electrode area and are made of plastic. The height of the chamber is several times the typical diameter of a particle. A glass cover 54 seals the top of the chamber. The glass substrate rests on the sample holding area 59 of a microscope 40. The microscope's illumination source 48 shines light up through a small aperture 49. The small aperture is created with the aperture mechanism 50 for the microscope. Once past the small aperture, light passes through the glass substrate 58 and past the gaps between the electrodes. Light then passes through the particles in the chamber and the glass cover over the chamber 54. Finally light passes through the optical system of the microscope 42 and onto the detector of a video camera 44. A computer 46 receives image data from the video camera and stores these images to its hard disk or memory for later processing. The computer 46 is a conventional personal computer. The computer connects to the video camera using a standard interface, such as IEEE1394. The computer controls a standard 50Ω signal source 34 that supplies an electrical signal to the electrodes. The signal source is connected to the electrodes via solder points 60. The signal source provides a 2 volt peak to peak signal. This electrical signal creates electric fields in the chamber. By analyzing images, the position of each particle relative to its nearest electrode may be determined.

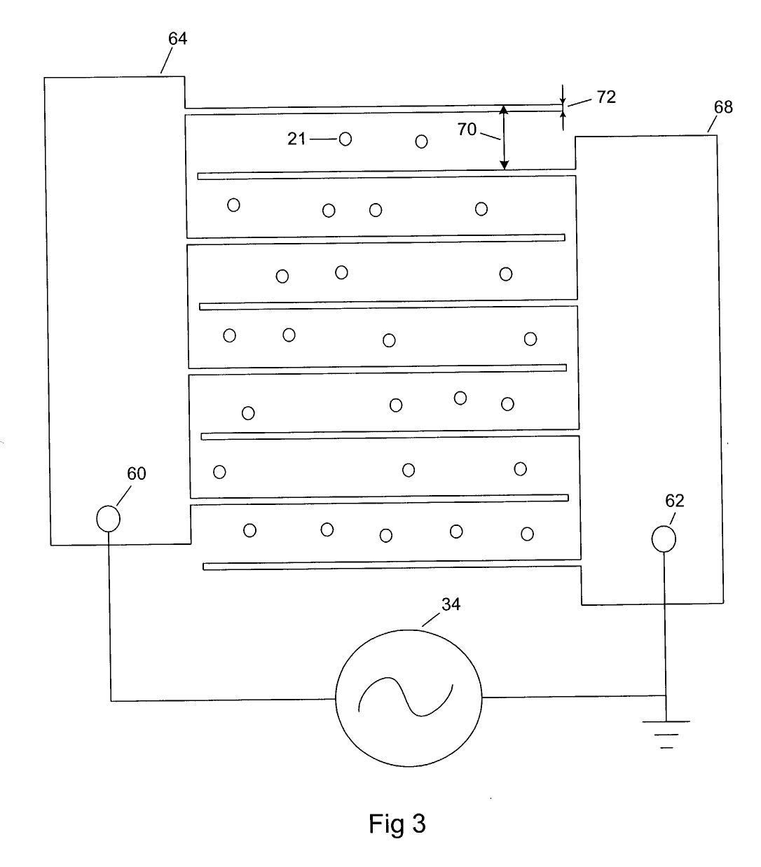

FIG. 3 is a plan view of the electrode geometry for the preferred embodiment of the apparatus. There are two independent conductive surfaces. One of these 68 is grounded, and the other 64 receives a sinusoidal voltage with an amplitude of 1 volt and a frequency that may ranges between 100 Hz to 10 MHz. Solder points 60 and 62 connect the signal generator 34 to the two electrodes. The width 72 of the finger-like electrode tips is 5 μm and the electrode spacing 70 is 50 μm. Particles 21 are repelled from the edges of the electrodes and suspended between the electrodes.

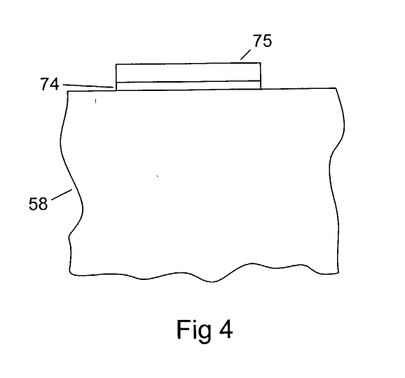

FIG. 4 is a cross-section view of an electrode. The electrode consists of a thin layer of chrome 74 with a thicker layer of gold on top 75. The chrome layer provides adhesion between the gold and the glass substrate 58. The gold layer is approximately 500 Å thick, and the chrome layer is approximately 100 Å thick. To fabricate the electrodes, follow these steps. First, clean the glass substrate with a hot solution of 30 percent hydrogen peroxide and 70 percent sulfuric acid. Second, deposit the metal layers using a metal sputtering system. Third, apply a layer of photoresist on the gold surface. Fourth, expose the photoresist using a patterned mask. Fifth, develop the photoresist using the standard procedure. Sixth, wet etch the metal layers using standard etchants for gold and chrome.

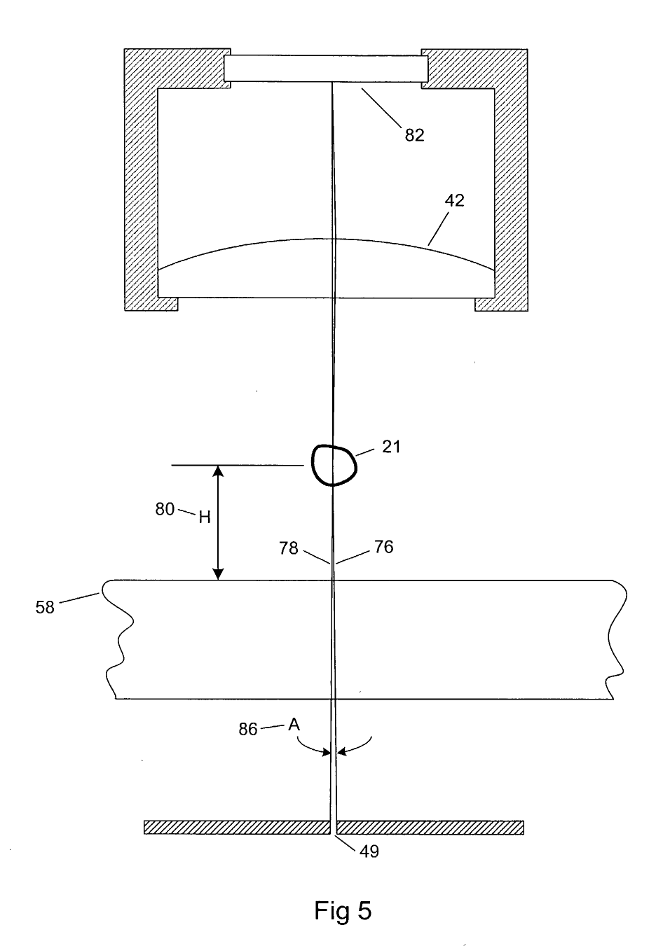

FIG. 5 shows the geometric relationship between parts of the apparatus and the particle 21 being measured. Consider the total spread of all rays of light 76, 78 that pass through the center of the particle. In this case the solid angle A 86 between the center of the particle and the aperture 49 is small. Therefore all rays passing through the particle are nearly parallel. As such, the focused image on the detector 82 is insensitive to the height of the particle H 80 above the substrate 58. This insensitivity to height is desirable because the characterization method involves the measurement of the horizontal position of the particle without regard to its height.

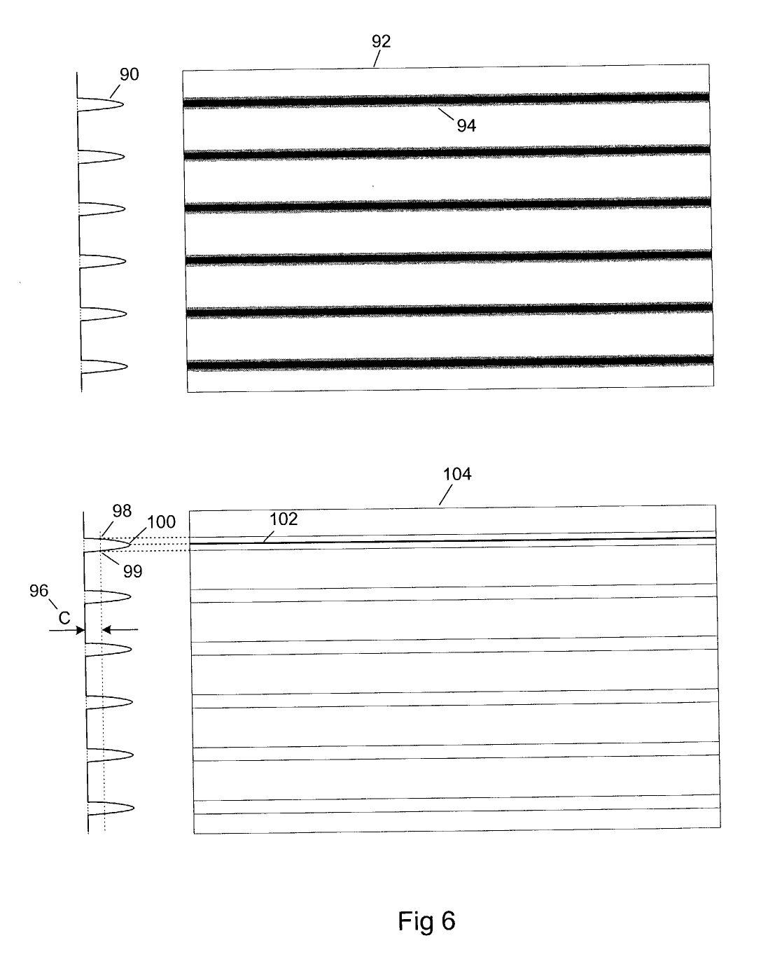

FIG. 6 illustrates an algorithm that may be used to determine the positions of the center of each electrode. An unprocessed image 92 contains dark horizontal bars 94 where each electrode blocks the incident light. Each horizontal row of pixels in the image may be summed to produce a one-dimensional array of numbers with troughs 90 at the vertical position of each electrode. A threshold range C 96 for the one-dimensional array is established such that only electrode regions have intensity values outside of this range. Electrode regions are defined as those regions (98 to 99 for instance) where the one-dimensional array is outside of the range C. The center of an electrode 102 may be defined as either the bottom of a trough 100 or the midpoint between the two transitions 98, 99 on either side of an electrode region. After processing, the positions of the electrodes in the image 104 may be reduced to a simple set of lines.

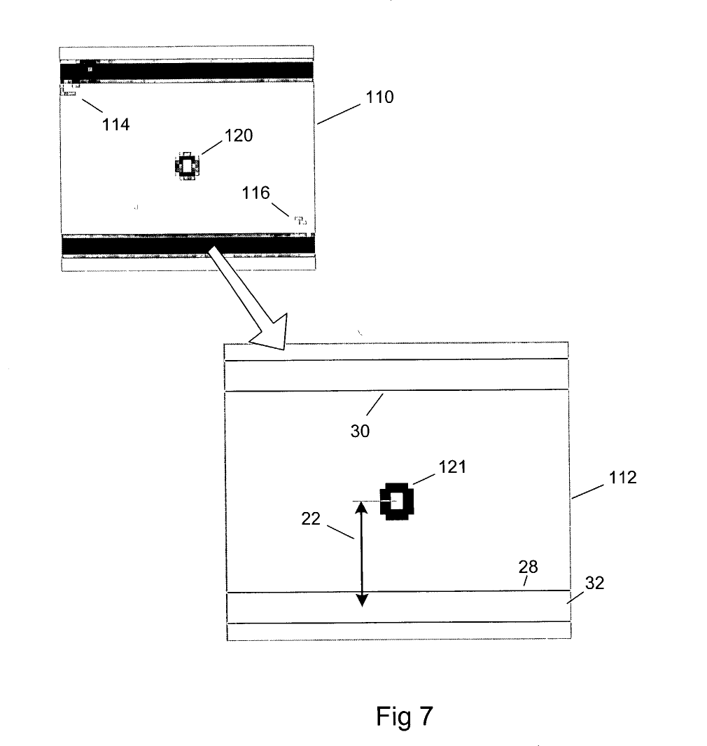

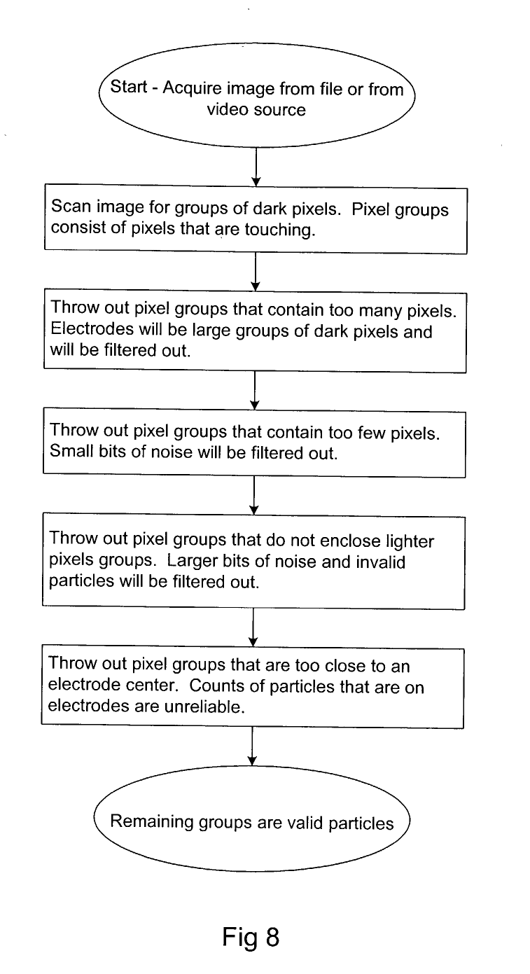

FIG. 7 shows part of an unprocessed image 110. The image contains one suspended particle 120, one particle in contact with an electrode 114, and some pixel noise 116. Using the algorithm described in FIG. 6, the electrode image is reduced to idealized coordinates 28, 30. The particle image 120 is distinguished from other image artifacts 114, 116 using the procedure described below in FIG. 8. The resultant image 112 contains the idealized representation of the particle 121.

FIG. 8 is a flowchart describing an algorithm that may be used to identify particles in an unprocessed image 110 (FIG. 7). The algorithm consists of first finding groups of dark pixels that are touching and then selectively filtering these groups. Particles will be have dark membranes and light interiors and will have sizes and shapes that are within a narrow range. Any groups of dark pixels that do not satisfy all criteria are discarded. The remaining groups of dark pixels are particles.

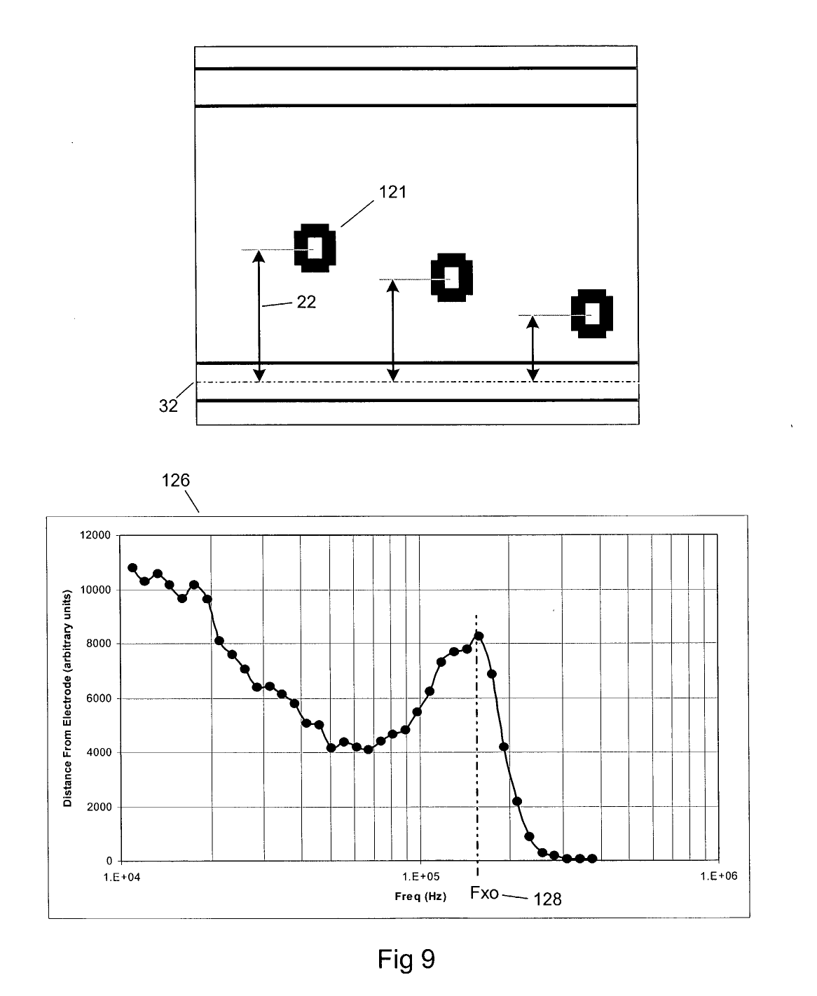

FIG. 9 illustrates the techniques used to reduce particle position to a plot 126 from which the crossover frequency, Fxo 128, for a population of particles may be derived. The crossover frequency may be used to compute important properties such as particle membrane capacitance and membrane conductance, Ratanachoo et al., “Detection of cellular responses to toxicants by dielectrophoresis”, Biochimica et Biophysica Acta 1564 (2002) 449-458.

In order to compute the crossover frequency, first compute the distance 22 from the center of each idealized cell image 121 to the center of the nearest electrode 32. The coordinate of the center of the particle 121 is computed as the center of mass of the pixels that make up the image of the particle. Compare the coordinate of each particle against the coordinate of each electrode to find the smallest distance 22. Second, sum all smallest distances for all particles. Divide this sum by the number of particles. The resultant value becomes one point on the spectral plot 126. Modify the frequency from the signal source and repeat. In this manner the spectral plot may be created. The crossover frequency 128 is the frequency at which the particles experience no net force either toward or away from the electrodes. The crossover frequency may be identified as the inflection point in the spectral plot 126. This is the frequency where the average distance between particles and electrodes reaches its maximum and begins to decrease.

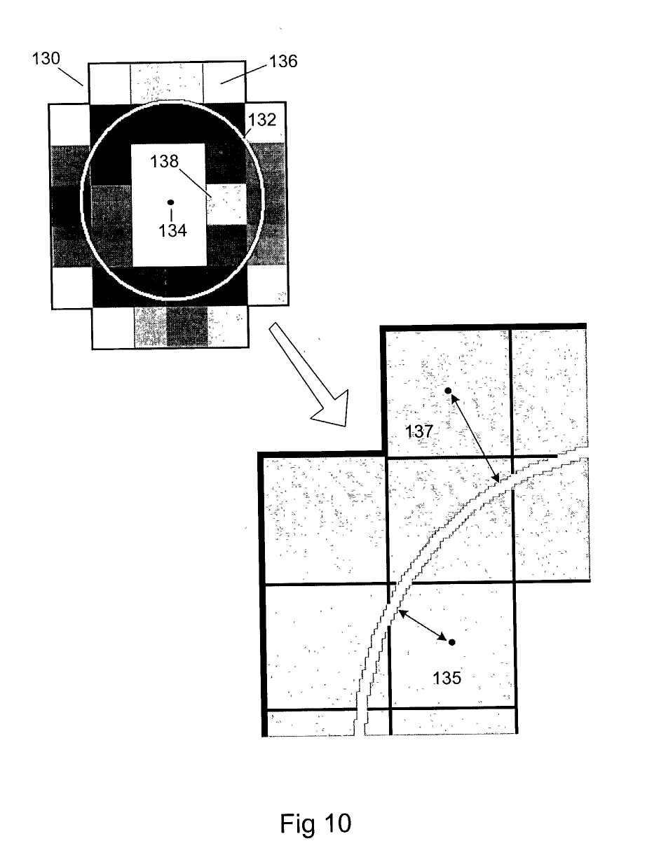

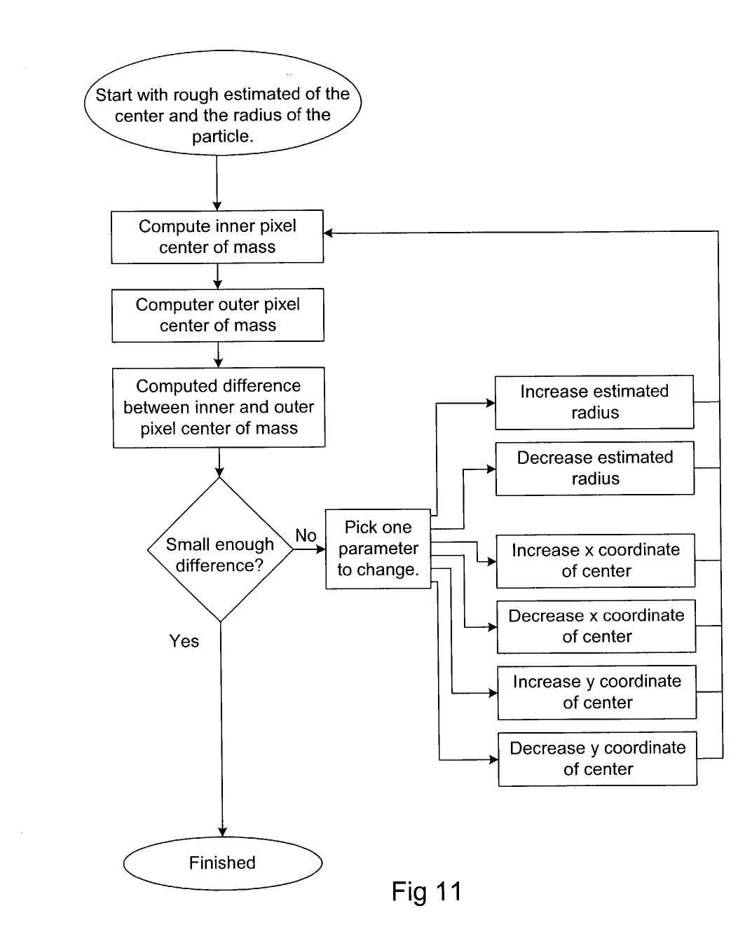

FIG. 10 shows an expanded view of one particle image 130 with a superimposed circle 132 that provides a sub pixel estimate of the radius of the particle. The center of the circle 134 is shown and the pixels that are inside the circle 138 and outside of the circle 136 are indicated. The distance between the center of a pixel and the edge of the circle is indicated 135, 137. The algorithm that fits a circle to a particle (see FIG. 11) uses this distance. In order to compute membrane capacitance and membrane conductance for the particle, the radius of each particle must be known, Ratanachoo et al., “Detection of cellular responses to toxicants by dielectrophoresis”, Biochimica et Biophysica Acta 1564 (2002) 449-458.

FIG. 11 is a flowchart describing the algorithm that computes a precise estimate of the radius of each particle.

The algorithm consists of the following. Start with a rough initial estimate of the radius and position of the particle. The initial estimate of the position is computed as the center of mass of the dark pixels that make up the boundary. These pixels are known from previous computations, FIG. 8. The estimate of the radius may be computed as one half the average of the width and height of the pixel group 130 (FIG. 10) for the particle.

Next cycle through all the dark pixels in the particle and determine which of these are inside the circle and which are outside the circle. Then compute the center of mass for all pixels that are inside the circle 138 and outside the circle 136.

The center of mass for one pixel is equal to the distance from the center of the pixel to the edge of the circle 135, 137 (FIG. 10). The center of mass for a group of pixels is the sum of all individual pixel center-of-mass values.

In all there are three parameters that need to be optimized, two for the position of the circle and one for its radius. Cycle through these three parameters, increasing or decreasing one parameter at a time until the difference between the center of mass of the inner and outer pixels is minimized. When the difference between the center of mass of the inner and outer pixels reaches a sufficiently low value, stop computing and use the current set of parameters for the circle. It is useful to plot the circle on an expanded view of the particle, as shown in FIG. 10, in order understand what a reasonable convergence value, i.e. small enough difference, is for this algorithm.

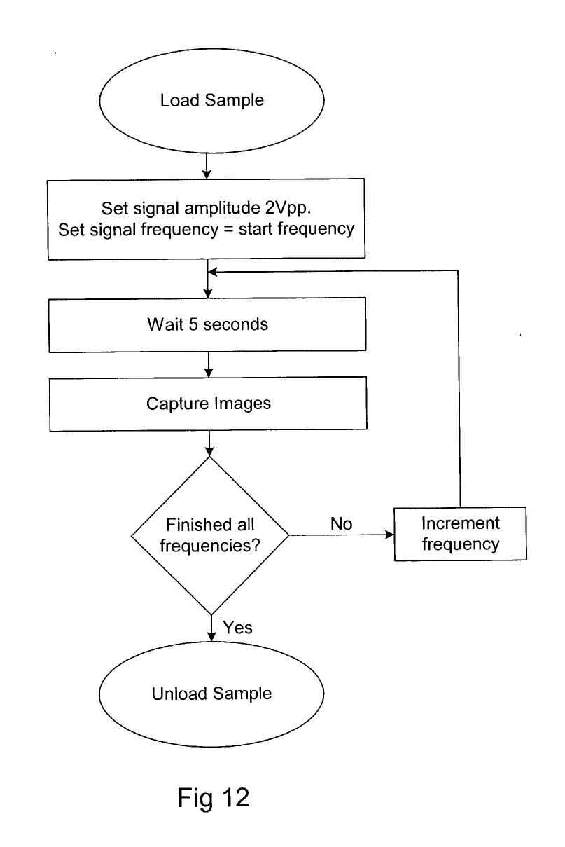

FIG. 12 is a flowchart describing the algorithm to collect image data for the spectral plot 126 from FIG. 9. First load the sample containing the particles into the chamber 52. As part of the loading process observe the output from the video camera 44. Wait for particles to settle onto the electrode surface and adjust the intensity of the light source 48 and the size of the aperture 49 so that particle membranes are distinct dark rings on a lighter background. Second, set the signal generator 34 to an initial frequency that is well below the expected crossover frequency. Set the amplitude of the signal generator to 2V peak to peak. Wait five seconds for the particles to reach their equilibrium positions. Capture images for the current frequency. Multiple images may be captured and their results averaged for each frequency data point. Increment the signal generator frequency through a range that is expected to include the crossover frequency. Do not modify the signal generator amplitude. When images have been captured for all desired frequencies, unload the sample.

The amplitude of the signal may be increased to provide sharper definition of the spectral plot or decreased to reduce required settling time between each frequency setting. The frequency increment may be adjusted around the crossover frequency to provide a more accurate estimate of the crossover frequency.

### OPERATIONAL DESCRIPTION OF THE INVENTION

Particles must be suspended in a fluid with the proper characteristics. The general requirement is that the fluid have different dielectric properties from the interior of the particle. When the particles are biological cells, it is sufficient to suspend the cells in a fluid with low electrical conductivity, on the order of 100 S/m or less. When the cells are baker's yeast (Saccharomyces Cerevisiae), use the following procedure: add deionized water to dried yeast in one beaker. Pipette about 5 ml of this high concentration activated yeast slurry into 400 ml of deionized water in another beaker. Then measure the conductivity, using a standard conductivity meter, of the diluted solution in the second beaker. Add small amounts of salt until the conductivity is on the order of 20 S/m. Place a drop of the 20 S/m fluid onto a microscope slide and place a cover slip on top of the drop. Adjust the microscope objective to 20x. If between 100 and 300 cells are visible in the field of view, then the diluted solution is ready. Otherwise, adjust the cell concentration of the dilute solution by adding water or by adding more of the high concentration yeast slurry. Adjust the conductivity by adding salt or water if necessary.

Once the dilute solution has been prepared, start using the instrument. Pipette a few drops of fluid into the fluid chamber 52. Place a cover glass 54 over the top of the chamber. Center the chamber over the microscope objective. Use 10x magnification and a video camera with 1024×768 pixels. Once the cells are in place, allow settling time. Watch the video output to determine when the cells have stopped moving. Make sure that the focal height of the microscope is on level with the cells. Start a computer program, as flowcharted in FIG. 12. This program applies the a signal via the signal generator 34, waits five seconds, captures images from the video camera 44, changes the signal frequency, waits five seconds, captures more images and so on. The program captures a series of images at different signal frequencies and saves them for later processing. Alternately, images may be processed as they are collected. The processing algorithms are described in FIG. 6, FIG. 7, FIG. 8, FIG. 9, FIG. 10, and FIG. 11.

One possible final product of this process is a plot of cell position relative to the electrodes vs. applied signal frequency. Average position for all cells may be computed without any attempt to identify cells across images. Alternatively, individual cells may be tracked between frames and the spectral response of individual cells may be computed. Cell tracking between images may be accomplished by comparing cell positions and sizes between frames in order to find the closet matches. Cell position and radius are available from the image processing described above.

In order to find the crossover frequency, identify the inflection point in the plot of cell positions. This is the point where the spectral plot 126 reaches a local maximum before dropping sharply. The crossover frequency plus cell radius may be used to compute biologically significant parameters such as cell membrane capacitance and conductance, Ratanachoo et al., “Detection of cellular responses to toxicants by dielectrophoresis”, Biochimica et Biophysica Acta 1564 (2002) 449-458.

### ALTERNATE EMBODIMENTS OF THE INVENTION

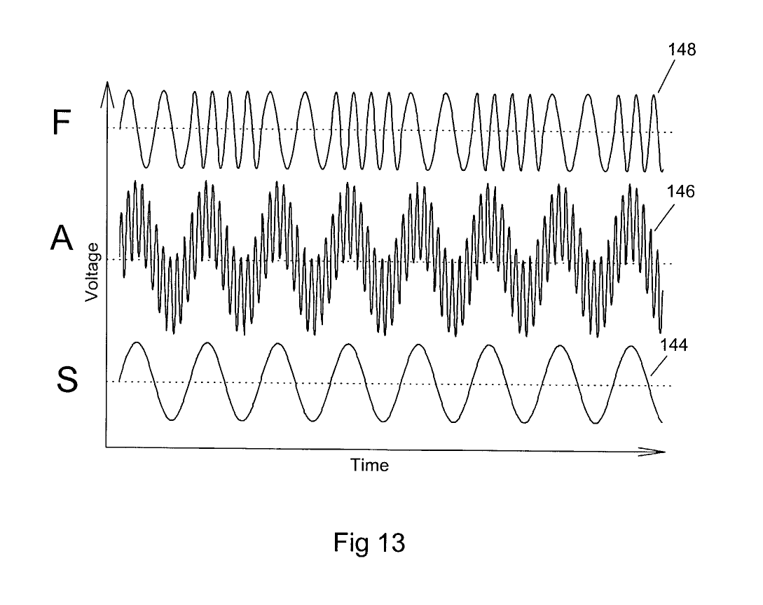

FIG. 13 shows various signal types that may be used. S 144 is a single frequency sine wave signal, produced by any standard signal source. A 146 is an amplitude-modulated signal containing two frequency components. F 148 is a frequency shift modulated signal containing two frequency components. Waveforms A and F are produced by many standard signal sources. Each particle experiences a force relative to the electrodes that depends on the sum of all signal frequencies. Therefore, by using more than one signal frequency at a time, it is possible to characterize different portions of the dielectrophoretic spectra for the particles. In a two-frequency system, one frequency is held constant while the other is incremented as described in FIG. 12.

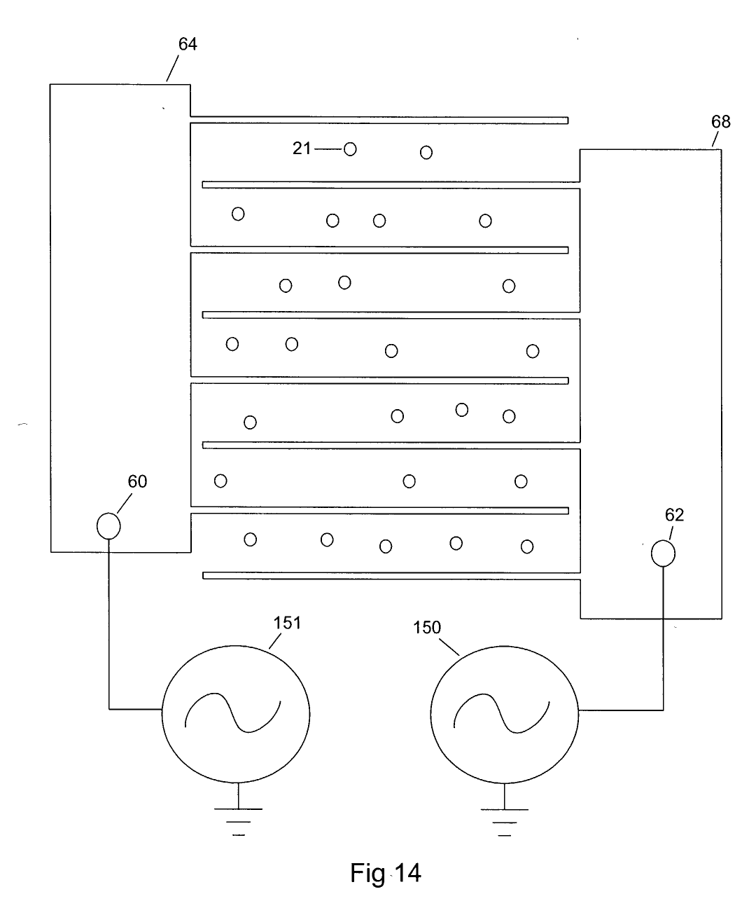

FIG. 14 is a plan view of a set of electrodes connected to two signal generators 150, 151. This is another way to engage the particles with two signal frequencies.

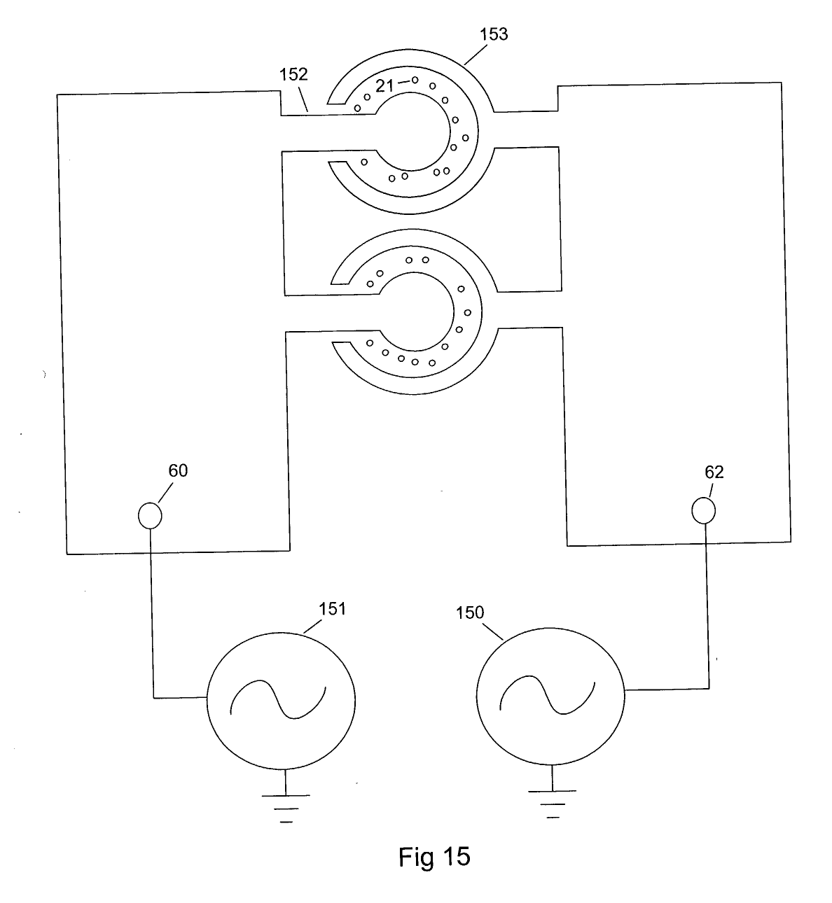

FIG. 15 is a plan view of curved electrodes that provide a gap for generating the same electric fields as the straight interdigitated electrodes shown in FIG. 14. In this case, one electrode 152 forms a ball and another 153, a socket. Any electrode configuration that provides conductive surfaces, separated by a small gap, may be used to produce electric fields to suspend and attract particles. Image processing required to compute the position of the electrodes shown in FIG. 15 is not as straightforward as for the electrodes shown in FIG. 14. However, for any electrode geometry, a numerical map of the edge of all electrode surfaces may be generated and all particle positions may be compared to all edge coordinates. Once the electrode edge positions are known, the characterization method described above may be used to find particle positions relative to electrode edges.

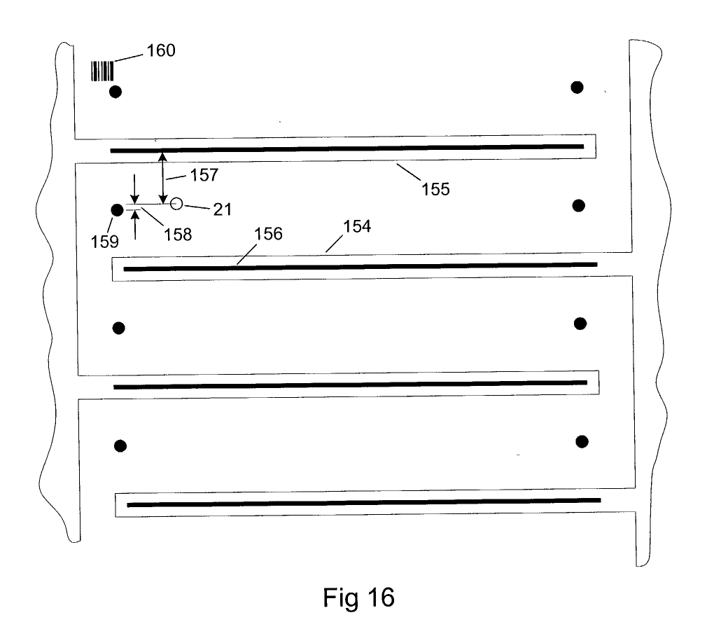

FIG. 16 shows an embodiment of the invention that includes three different types of fiducial marks on the substrate. When the electrode is transparent 154, 155, then an opaque mark may be placed on top of the electrode. A fiducial line 156 is shown as a reference to the middle of the electrode. Fiducials may also be placed outside of the electrode area 159 and may take on the form of small bar codes 160 to provide more information. Fiducials serve as reference marks for determining the positions of particles 21. The distance 157, 158 between a fiducial and a particle may be computed using previously described techniques. The previously described techniques for finding the pixel coordinates of electrodes apply equally well to fiducials.

Fiducials may be fabricated using the same photolithographic techniques as are used to fabricate the gold/chrome electrodes and may be made of the same materials. Transparent electrodes may be made using photolithographic techniques developed for the production of inexpensive solar cells, for example, U.S. Pat. No. 5,420,043 to Niwa et al (1995).

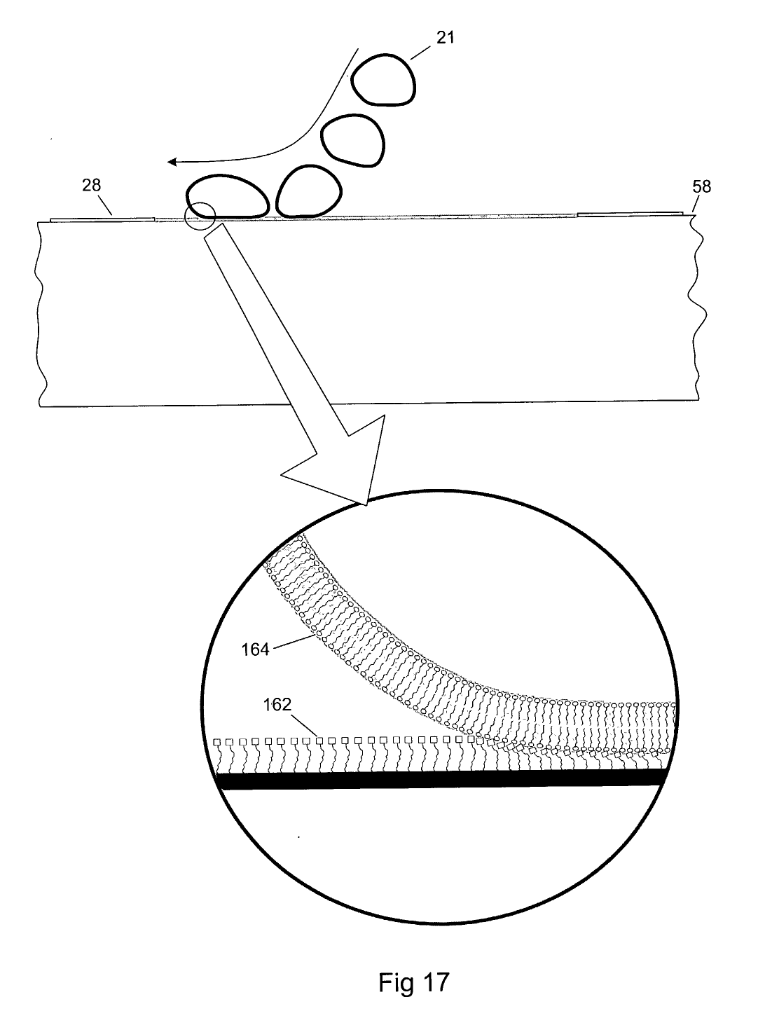

FIG. 17 shows an embodiment of the invention where the substrate surface 58 is coated with molecules 162 that may or may not adhere to the surface molecules 164 of a particle 21. The dielectrophoretic spectra will be affected by the drag force on the particle as it travels across the coated surface. Specifically, the downward plunge of the plot following Fxo, FIG. 9, will be smeared out as particles resist motion toward the electrodes.

### THEORY OF OPERATION

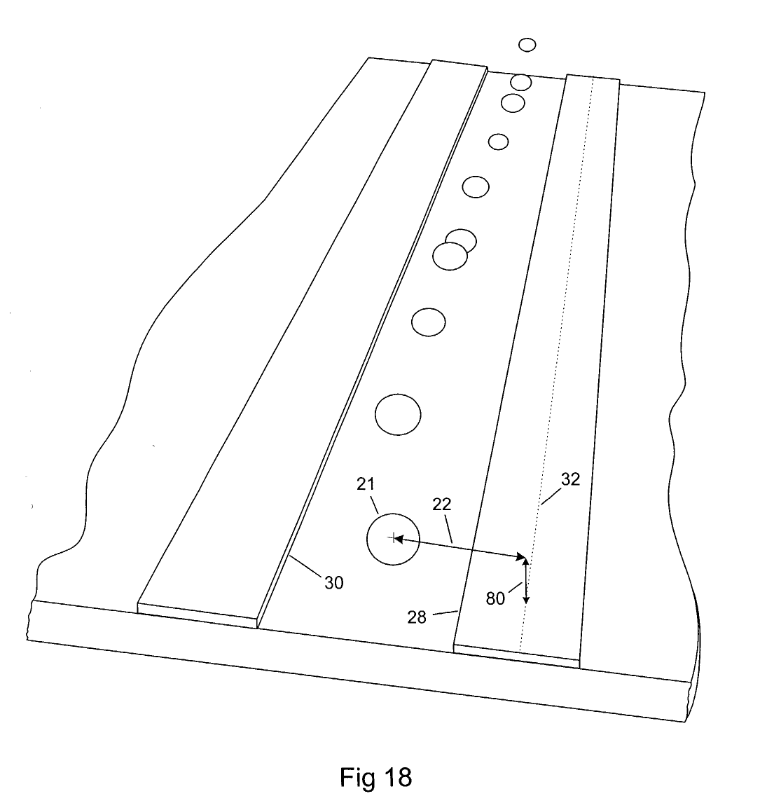

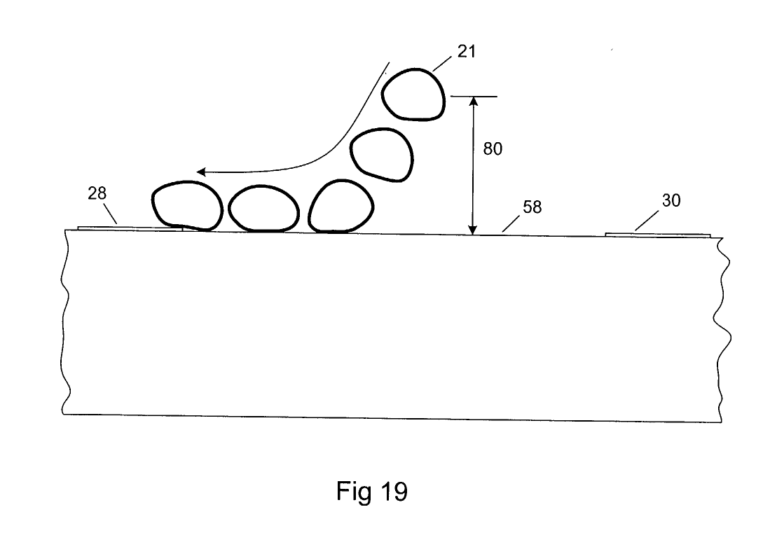

The invention works by controlling a timed sequence of alternating electromagnetic fields while measuring the position of particles within the fields. Considering one particle 21 as shown in FIG. 18 and FIG. 19, at field frequencies below the crossover frequency 128, FIG. 9, the particle is pushed away 22 from and suspended above 80 the electrodes 28, 30. As the field frequency decreases, the repulsive force decreases and the particle descends to the substrate surface 58. The time required for the particle to descend is at least several seconds. Therefore, depending on the rate at which the signal frequency is increased, the particle will experience an attractive force and will start to move toward one or the other electrode before it touches the substrate surface. As the particle contacts the substrate surface it initially touches the surface lightly, but is increasingly driven into contact with the substrate surface and ultimately up against the edge of the electrode where the attractive force is strongest.

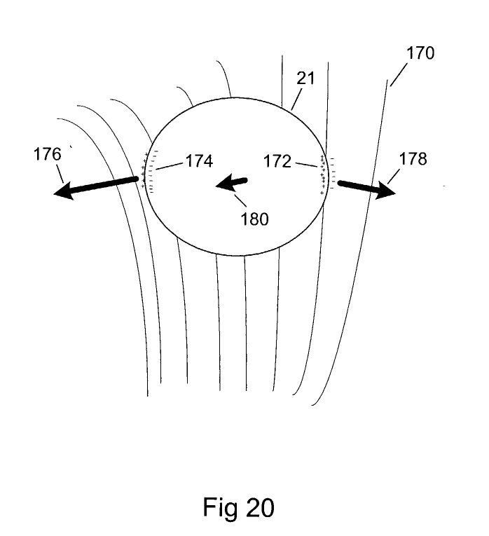

The invention uses the dielectrophoretic force, which is induced on particles that are polarized in the presence of a non-uniform alternating electric field. FIG. 20 shows an instantaneous snapshot of a particle 21 in a non-uniform electric field. The spacing between field lines 170 indicates the change in the electric field strength. Both the left and the right side of the particle have charge imbalance. On the left side there is more negative charge 174 inside the particle than positive charge outside the particle. On the right side there is more positive charge 172 inside the particle than negative charge outside the particle. This charge imbalance occurs because the fluid outside the particle has fewer ions than the fluid inside the particle. The force on left side of the particle 176 is proportional to the charge imbalance times the strength of the electric field. Likewise the force on the right side of the particle 178 is equal to the charge imbalance times the strength of the electric field. Since the charge imbalance on the left and right side of the particle has opposite signs, the forces on either side of the particle have opposite directions. However, since the electric field is stronger on the left side of the particle, the force on the left side of the particle is stronger than the force on the right side of the particle. Thus the net force on the particle 180 is to the left. The biologically interesting properties of the dielectrophoretic force have to do with the dynamic buildup of charge on the membrane and the flow of charge across the membrane. For a detailed discussion of dielectrophoretic theory please see the following, Gascoyne et al., “Dielectrophoretic detection of changes in erythrocyte membranes following malarial infection”, Biochimica et Biophysica Acta 1323 (1997) 240-252.

### CONCLUSIONS, RAMIFICATIONS AND SCOPE OF INVENTION

The invention precisely characterizes hundred of particles during a three-minute measurement run. The apparatus parts may be readily purchased or fabricated using standard techniques. The application of the invention is widespread when the particles are biological cells, as it can determine cell conductive properties without contacting cells, without destroying cells, and with one common set of instrumentation. The current invention also has better measurement fidelity, is less expensive to implement, and has higher throughput than do other dielectrophoretic characterization techniques.

While the above description contains many specific details, these should not be construed as limitations on the scope of the invention, but rather as examples of various embodiments of the invention. Many other variations are possible. For example, fluid and sample handling capabilities may be added to introduce particles to the chamber and to remove particles from the chamber. Alternatively, fluid handling may be added to enable the electrical or chemical properties of the fluid in the chamber to be modified. Such changes enhance the measurement capability of the system and serve to further automate the operation of the invention. To increase the productivity of the invention, it may be desirable to add multiple arrays of structures to distribute the signal. Further, it may be desirable to add multiple detectors 82 to facilitate parallel data collection. More than one computer system 46 may be used to drive the various pieces of the system or to process data as it is collected. The microscope 40 may be replaced by a customized mechanical system. The light source 48 may be either above or below the chamber 52 and the detector may be either above or below the chamber. Electrodes may be made of any conductive material not simply chrome 74 under gold 75. The substrate 58 may be any transparent or translucent material, or alternatively the substrate may be a material that emits diffuse light. The electrodes 64, 68 may be opaque or transparent. The chamber walls 56 may be made of adhesive electrical tape or plastic that is affixed and patterned using photolithographic techniques or of any other thin, low conductivity substance that will contain the contents of the chamber. If the chamber walls are far away from the electrode area, the chamber walls may be conductive.

I claim:

1. A method for measuring the response of more than one particle to a set of electrical fields, comprising the steps of:
a. positioning said particles such that a net induced dielectrophoretic force influences the position of said particles, and
b. measuring said position of said particles with respect the position of said electrical fields, and,
c. modifying said electrical fields and repeating said measurements,
whereby the dielectrophoretic response of said particles is measured.

2. The method of claim 1 wherein said position of said particles is measured with respect to conductive electrode surfaces.

3. The method of claim 1 wherein said position of said particles is measured with respect to fiducial marks.

4. The method of claim 1 wherein said electrical fields are induced by electrical signals on conductive electrode surfaces.

5. The method of claim 4 wherein said dielectrophoretic forces are modified by altering the frequency of said electrical signal.

6. The method of claim 1 wherein said positions of said particles are measured by computer analysis of images.

7. The method of claim 1 wherein said positions of said particles are tracked with respect to conductive electrodes.

8. The method of claim 7 wherein said positions are measured by computer analysis of images.

9. A measurement device, comprising:
a. a means of creating electrical fields that induce dielectrophoretic forces on more than one particle, and
b. a means of measuring the position of said particles with respect to the source of said electrical fields, and
c. a means of modifying said electrical fields and repeating said measurements
whereby the dielectrophoretic response of said particles is measured.

10. The measurement device of claim 9 wherein said positions of said particles are measured by analyzing images that include particles and opaque electrodes.

11. The measurement device of claim 10 wherein said dielectrophoretic forces are modified by altering the frequency of the applied electrical signal.

12. The measurement device of claim 9 wherein said positions of said particles are measured by analyzing images that include particles and ficucial marks.

13. The measurement device of claim 9 wherein said electrical fields are induced by electrical signals on conductive electrode surfaces.

14. The measurement device of claim 9 wherein the opaque electrodes consist of a set of interdigitated lines.

15. A measurement device, comprising:
a. a means of creating electrical fields that induce dielectrophoretic forces that bring more than one particles into contact with a chemically coated surface, and
b. a means of measuring the position of said particles with respect to the source of said electrical fields, and
c. a means of modifying said electrical fields and repeating said measurements
whereby the contact force of said particles on said coated surface may be measured.

16. The measurement device of claim 15 wherein said dielectrophoretic forces are modified by altering the frequency of an electrical signal applied to a set of electrodes.

17. The measurement device of claim 15 wherein said dielectrophoretic force is modified by altering the amplitude of an electrical signal applied to a set of electrodes.
